(19) United States
(12) Patent Application Publication
(10) Pub. No.: US 2026/0333408 A1
(43) Pub. Date: Oct. 22, 2026

(54) UE-TRIGGERED TIME DOMAIN CHANNEL PROPERTY REPORT

(71) Applicant: Google LLC, Mountain View, CA (US)

(72) Inventors: Yushu Zhang, Beijing (CN); Chih-Hsiang Wu, Taipei (TW)

(21) Appl. No.: 19/115,662

(22) PCT Filed: Sep. 30, 2022
(86) PCT No.: PCT/CN2022/123629

§ 371 Date: Mar. 26, 2025

(51) Int. Cl. H04W 72/542; H04W 8/24; H04W 72/1268; H04W 72/23

(52) U.S. Cl. CPC H04W 72/542; H04W 8/24; H04W 72/1268; H04W 72/23

(57) ABSTRACT

This disclosure provides systems, devices, apparatus, and methods, including computer programs encoded on storage media, for UE-triggered TDCP reports. A UE (102) receives (208), from a network entity (104), control signaling that indicates a triggering condition for the TDCP report. The triggering condition is associated with a measurement value of at least one downlink reference signal. The UE (102) receives (210a-210b), from the network entity (104), the at least one downlink reference signal, where the measurement value of the at least one downlink reference signal can correspond to detection of the triggering condition for the TDCP report. The UE (102) transmits (218) to the network entity (104), and the network entity (104) receives (218) from the UE (102), the TDCP report based on the detection of the triggering condition for the TDCP report.

### TECHNICAL FIELD

The present disclosure relates generally to wireless communication, and more particularly, to user equipment (UE)-triggered time domain channel property (TDCP) reports.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. As mobile broadband technologies evolve, improvements in mobile broadband have been useful to continue the progression of such technologies. For example, time domain channel property (TDCP) reporting might be associated with increased overhead or increased latency if a TDCP reporting periodicity is too short or too long, respectively.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delincates the scope of any or all aspects. Its sole purpose is to present some concepts of one or more aspects in a simplified form as a prelude to the more detailed description that is presented later.

A network entity, such as a base station or an entity of a base station, can trigger a user equipment (UE) to measure and report one or more time-domain channel properties (TDCPs). The TDCPs correspond to Doppler-related information, such as Doppler spread or Doppler shift, and may include average delay and average shift. TDCPs represent a time-domain channel correlation measured from different tracking reference signal (TRS) symbols. The one or more reported TDCPs can assist the network entity with configuring a channel state information (CSI) report and/or a CSI resource based on a CSI measurement and reporting overhead. For example, if the TDCP is large, the network entity might configure the CSI report and the CSI resource more frequently. Otherwise, the network entity might configure the CSI report and the CSI resource less frequently to decrease the overhead associated with CSI measurement and reporting.

Some network entities might not be able to determine when conditions at the UE would merit triggering of the TDCP report. Consequently, a network entity could trigger the TDCP report too frequently (e.g., by configuring a short periodicity), which would cause an increase in the overhead for the TDCP report. Alternatively, the network entity could trigger the TDCP report too infrequently (e.g., by configuring a longer periodicity), which might allow the UE to experience significant changes in the TDCP before an uplink resource is available for the UE to transmit the TDCP report.

Aspects of the present disclosure address the above-noted and other deficiencies by implementing a UE-triggered TDCP report that reduces the overhead and/or TDCP reporting latency associated with some network entity-triggered TDCP reports.

According to some aspects, the UE receives, from the network entity, control signaling that indicates a triggering condition for the TDCP report. The triggering condition is associated with a measurement value of at least one downlink reference signal. The UE receives, from the network entity, the at least one downlink reference signal, where the measurement value of the at least one downlink reference signal can correspond to detection of the triggering condition for the TDCP report. The UE transmits to the network entity (and the network entity receives from the UE) the TDCP report based on the detection of the triggering condition for the TDCP report.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system including a plurality of network entities in communication over a plurality of cells.

FIG. 2 is a signaling diagram that illustrates a triggering procedure for a time domain channel property (TDCP) report.

FIGS. 3A-3B are signaling diagrams that illustrate triggering procedures for TDCP reporting in dual-connectivity (DC) architectures.

FIG. 4 is a signaling diagram that illustrates a TDCP report transmitted via a medium access control-control element (MAC-CE).

FIG. 5 is a signaling diagram that illustrates a one-step TDCP report transmission on physical uplink control channel (PUCCH) resources.

FIG. 6 is a signaling diagram that illustrates a two-step TDCP report transmission on physical uplink shared channel (PUSCH) resources.

FIG. 7 is a flowchart of a method of wireless communication at a user equipment (UE).

FIG. 8 is a flowchart of a method of wireless communication at a network entity.

FIG. 9 is a diagram illustrating an example of a hardware implementation for an example UE apparatus.

FIG. 10 is a diagram illustrating an example of a hardware implementation for one or more example network entities.

### DETAILED DESCRIPTION

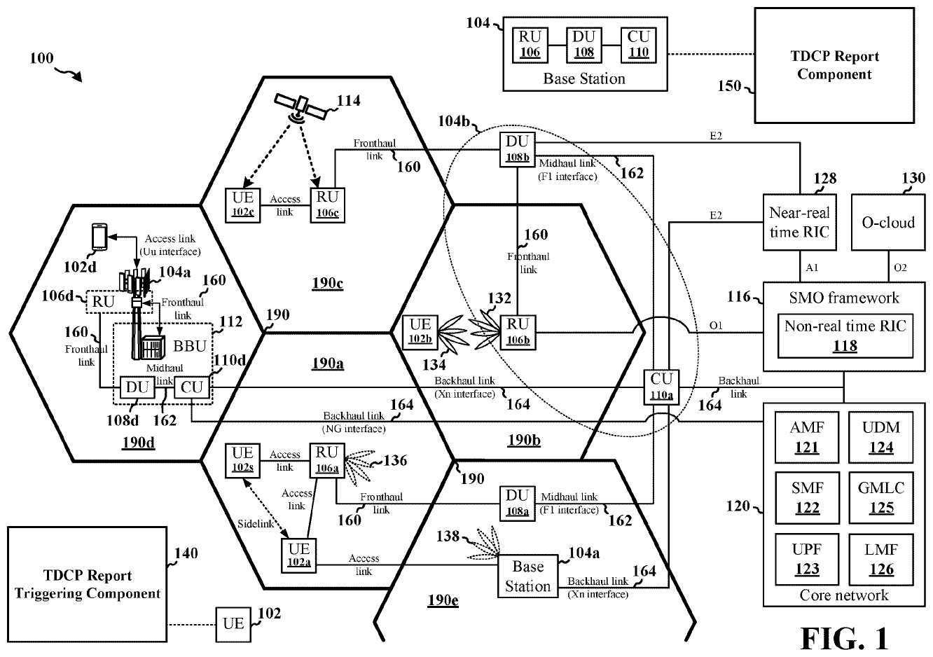

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an AI link. The SMO framework 116 and/or the non-real time RIC 118 might also communicate with an open cloud (O-cloud) 130 via an 02 link. The one or more CUs 110 may further communicate with each other over a backhaul link 164 based on an Xn interface. For example, the CU 110d of the base station 104a communicates with the CU 110a of the base station 104b over the backhaul link 164 based on the Xn interface. Similarly, the base station 104a of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (IFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the 02 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the AI interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the 02 link for deployment of the AI/ML models to the real-time RIC 128 via the AI link. The near-real time RIC 128 may utilize the parameters and/or other information received from the non-real time RIC 118 or the SMO framework 116 via the AI link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the AI link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz -24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a time domain channel property (TDCP) report triggering component 140 configured to receive, from a network entity, control signaling that indicates a triggering condition for a TDCP report, where the triggering condition is associated with a measurement value of at least one downlink reference signal; receive, from the network entity, the at least one downlink reference signal, where the measurement value of the at least one downlink reference signal corresponds to a detection of the triggering condition for the TDCP report; and transmit, to the network entity, the TDCP report based on the detection of the triggering condition for the TDCP report.

In certain aspects, the base station 104 or a network entity of the base station 104 may include a TDCP report component 150 configured to transmit, to a UE, control signaling that indicates a triggering condition for a TDCP report, where the triggering condition is associated with a measurement value of at least one downlink reference signal; transmit, to the UE, the at least one downlink reference signal, where the measurement value of the at least one downlink reference signal corresponds to a detection of the triggering condition for the TDCP report; and receive, from the UE, the TDCP report based on the detection of the triggering condition for the TDCP report. Although the following description may be focused on 5G NR, the concepts described herein may be applicable to other similar areas, such as 5G-Advanced and future versions, LTE, LTE-advanced (LTE-A), and other wireless technologies.

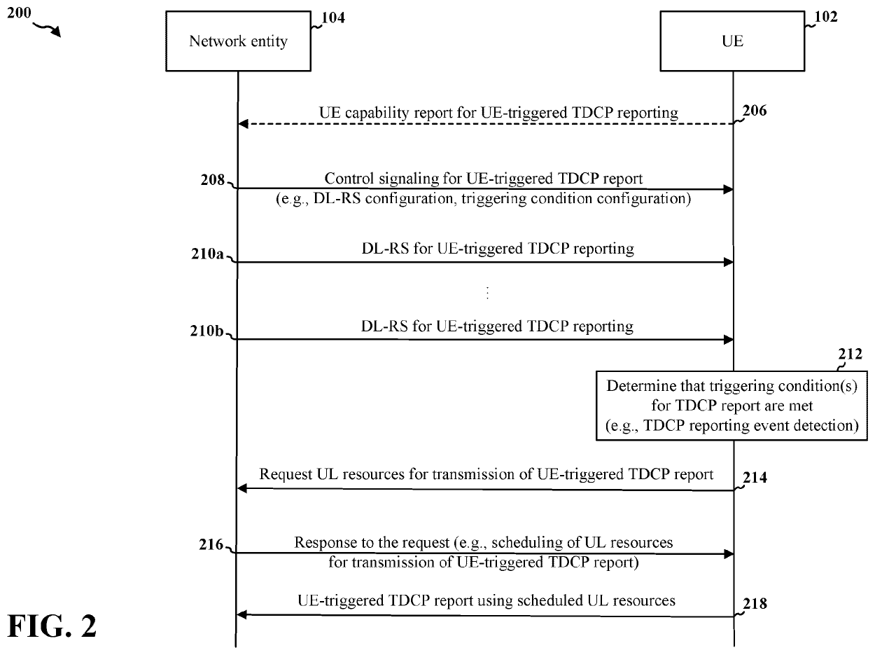

FIG. 2 is a signaling diagram 200 that illustrates a triggering procedure for a TDCP report. UE movement within a wireless communication environment may cause a phase shift to a channel path k as a result of Doppler effect. Thus, a UE 102 and/or a network entity 104, such as a base station or an entity of a base station, might determine a Doppler shift for the channel path based on factors such as UE acceleration or speed, UE velocity, carrier frequency, angle of arrival for the channel path, etc. In some examples, a Doppler shift for the channel path is determined based on one, some, or all of these factors. Although channel paths for a multi-path channel might be associated with a common UE speed (or velocity) and carrier frequency, the Doppler shift for each channel path might be different due to different angles of arrivals for the different paths. The phase shift for the channel path k as a result of the Doppler shift can be calculated based on:

$${γ}_{k} = exp ( j 2 π \frac{{r}_{k} \times v}{λ} t )$$

rₖ=[sinθₖ cosφₖ sinθₖ sinφₖ cosθₖ]

v=v₀[sinθᵥ cosφᵥ sinθᵥ sinφᵥ cosθᵥ]^{T}

where λ corresponds to a waveform length determined based on the carrier frequency, t corresponds to time, θₖ corresponds to a zenith angle of arrival (ZoA) for the channel path k, φₖ corresponds to an azimuth angle of arrival (AoA) for the channel path k, v₀ corresponds to a moving speed (or velocity) of the UE 102, θᵥ corresponds to a vertical moving direction of the UE 102, and oy corresponds to a horizontal moving direction of the UE 102.

The UE 102 may report 206 a UE capability to the network entity 104 for UE-triggered TDCP reporting. One or more UE capabilities included in the UE capability report may indicate whether the UE 102 supports UE-triggered TDCP reporting as well as information such as a maximum number of downlink reference signals (DL-RSs) that the UE 102 supports for UE-triggered TDCP reporting. In other examples, the network entity 104 may receive the one or more UE capabilities from a core network entity, such as an AMF. The UE capability report may also indicate a number of channel state information (CSI) processing units that the UE 102 supports. If scheduling by the network entity 104 corresponds to more parallel CSI processing than the number of CSI processing units reported 206 in the UE capability report, the UE 102 may include non-current CSI (e.g., prior CSI) in low priority CSI reports. In some examples, the UE 102 might determine a priority of a particular CSI report based on predefined protocols. For example, a CSI processing unit occupancy rule for periodic/semi-persistent/aperiodic CSI reports may be based on the predefined protocols.

The UE 102 might measure a channel state information-reference signal (CSI-RS) for tracking, which may also be referred to as a tracking reference signal (TRS), to perform time and frequency offset tracking. The time and frequency offset tracking can include Doppler shift and Doppler spread estimations. The TRS might correspond to a CSI-RS resource set associated with a configured RRC parameter (e.g., trs-Info). The network entity 104 can transmit 208 control signaling, such as RRC signaling, to configure a periodic TRS (e.g., via a non-zero power (NZP)-CSI-RS-ResourceSet configured with higher layer parameter trs-Info) or trigger an aperiodic TRS via downlink control information (DCI). In examples, the network entity 104 may configure a downlink reference signal, such as the TRS, to be transmitted 210a-210b in two symbols of a slot or in four symbols distributed across two consecutive slots, where two CSI-RS resources or four CSI-RS resources may be associated with the NZP-CSI-RS-ResourceSet configured with the higher layer parameter trs-Info. Hence, the UE 102 can estimate the Doppler shift and/or the Doppler spread for downlink decoding based on reception 210a-210b and measurement of the TRS from the network entity 104.

The aperiodic TRS might be quasi-co-located (QCLed) with the periodic TRS, such that the network entity 104 can provide a QCL indication to the UE 102 through DCI. The network entity 104 may configure a QCL type and/or a source reference signal for the QCL signaling. QCL types for downlink reference signals might be based on a higher layer parameter, such a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter.

The network entity 104 may use CSI to select a digital precoder for the UE 102 in a multiple-input multiple-output (MIMO) system. The network entity 104 might transmit 208 control signaling to the UE 102 to configure the UE 102 for a UE-triggered TDCP report (e.g., DL-RS configuration, triggering condition configuration, etc.). In examples, the network entity 104 can configure a CSI report through the control signaling, such as RRC signaling (e.g., CSI-reportConfig), for the UE 102 to use a CSI-RS as a channel measurement resource (CMR) for measuring a downlink channel. The network entity 104 might also configure (e.g., via the CSI-reportConfig) an interference measurement resource (IMR) for the UE 102 to measure interference. The UE 102 can obtain the CSI based on the CMR and/or the IMR. which may include a rank indicator (RI), a precoder matrix indicator (PMI), a channel quality indicator (CQI), a layer indicator (LI), etc. The network entity 104 may determine the digital precoder based on the RI and the PMI. The CQI is indicative of a status of a signal-to-interference plus noise (SINR) for determining a modulation and coding scheme (MCS). The LI can indicate a strongest layer for multi-user (MU)-MIMO paring with a low rank transmission and a selected precoder for a phase-tracking reference signal (PT-RS). In some examples, the network entity 104 transmits an RRC message, such as an RRCReconfiguration message, to the UE 102 that indicates the DL-RSs for UE-triggered TDCP reporting, uplink resource for requesting transmission of the TDCP report, etc.

The network entity 104 might transmit 208 the control signaling to configure a time domain behavior (e.g., periodic/semi-persistent/aperiodic) for CSI reporting via the CSI-reportConfig. The network entity 104 may activate or deactivate a semi-persistent CSI report based on transmission of a MAC-control element (MAC-CE) to the UE 102. The network entity 104 may trigger an aperiodic CSI report based on transmission of a DCI to the UE 102. The UE 102 may be configured to transmit a periodic CSI report to the network entity 104 on a physical uplink control channel (PUCCH) resource indicated in the CSI-reportConfig. The UE 102 may be configured to transmit a semi-persistent CSI report on the PUCCH resource indicated in the CSI-reportConfig or on a physical uplink shared channel (PUSCH) resource indicated in DCI received from the network entity 104. The UE 102 may be configured to transmit an aperiodic CSI report on the PUSCH resource indicated in the DCI received from the network entity 104. The network entity 104 might configure the UE 102 with multiple CSI-reportConfig information elements (IEs) for multiple CSI measurements and reports. Further, the UE 102 might process multiple CSI measurements and reports in parallel based on one or more CSI processing units.

A first CSI processing unit duration for the periodic/semi-persistent CSI report might correspond to a CSI processing unit having an occupancy that begins at a first symbol of earliest resources for the CMR or the IMR used for measurements by the UE 102. For example, the UE 102 may perform one or more measurements of the CSI-RS, CSI-interference measurement (CSI-IM), a synchronization signal block (SSB), etc. The first CSI processing unit duration for the periodic/semi-persistent CSI report may continue through last resources for the CMR and the IMR used for the measurement of the UE 102 and end at a last symbol of a PUSCH/PUCCH used by the UE 102 for transmitting the periodic/semi-persistent CSI report to the network entity 104.

A second CSI processing unit duration for the aperiodic CSI report may correspond to a CSI processing unit having an occupancy that begins at a first symbol after receiving a PDCCH that triggers the aperiodic CSI report. The second CSI processing unit duration for the aperiodic CSI report may continue through last resources for the CMR and the IMR used for the measurement of the UE 102 and end at a last symbol of a PUSCH used by the UE 102 for transmitting the aperiodic CSI report to the network entity 104. If the PDCCH that triggers the aperiodic CSI report corresponds to two PDCCH candidates from two respective search space sets, the PDCCH candidate that ends later in time is used for determining the second CSI processing unit duration for the aperiodic CSI report.

If the PDCCH triggers an initial semi-persistent CSI report on the PUSCH, the CSI processing unit duration for the initial semi-persistent CSI report should not be the same as the first CSI processing unit duration for the periodic/semi-persistent CSI report. Instead, the CSI processing unit duration for the initial semi-persistent CSI report may correspond to the second CSI processing unit duration for the aperiodic CSI report. That is, the CSI processing unit duration for the initial semi-persistent CSI report transmitted on the PUSCH, after the PDCCH, begins at the first symbol after the PDCCH and ends at the last symbol of the PUSCH that carries the initial semi-persistent CSI report. If the PDCCH that triggers the initial semi-persistent CSI report corresponds to two PDCCH candidates from two respective search space sets, the PDCCH candidate that ends later in time is used for determining the CSI processing unit duration for the initial semi-persistent CSI report.

The network entity 104 may trigger the UE 102 to measure and report TDCP based on transmission(s) 210a-210b of periodically, semi-persistently or aperiodically DL-RSs, such as TRS. The TDCP may correspond to Doppler-related information, such as Doppler spread or Doppler shift, as well as time-domain channel correlation for channels measured at different TRS symbols. The network entity 104 may use the reported TDCP for configuring the CSI report and the CSI resource with a suitable overhead. For example, if the TDCP is large, the network entity 104 can configure the CSI report and the CSI resource more frequently. Otherwise, the network entity 104 can configure less-frequent CSI reports and less CSI resources to reduce the overhead for CSI measurement and reporting.

In some examples, the network entity 104 might not be able to trigger the TDCP report at an exact time that conditions at the UE 102 would be most suited for triggering the TDCP report. If the network entity 104 triggers the TDCP report too frequently (e.g. a periodicity for periodic or semi-persistent TDCP reporting is configured with a small value) or an interval between two aperiodic TDCP reports corresponds to the small value, the overhead for the TDCP report might be large. Conversely, if the network entity 104 triggers the TDCP report too infrequently (e.g., the periodicity for periodic or semi-persistent TDCP reporting is configured with a large value) or the interval between the two aperiodic TDCP reports corresponds to a large value, the network entity 104 might not be able to identify TDCP status changes with sufficiently low latency. For example, the UE 102 might have to wait for an uplink resource to occur before the UE 102 can transmit the TDCP report to the network entity 104. Further, if the TDCP experienced at the UE 102 changes more frequently than the TDCP is reported, some TDCP status changes might not get reported to the network entity 104.

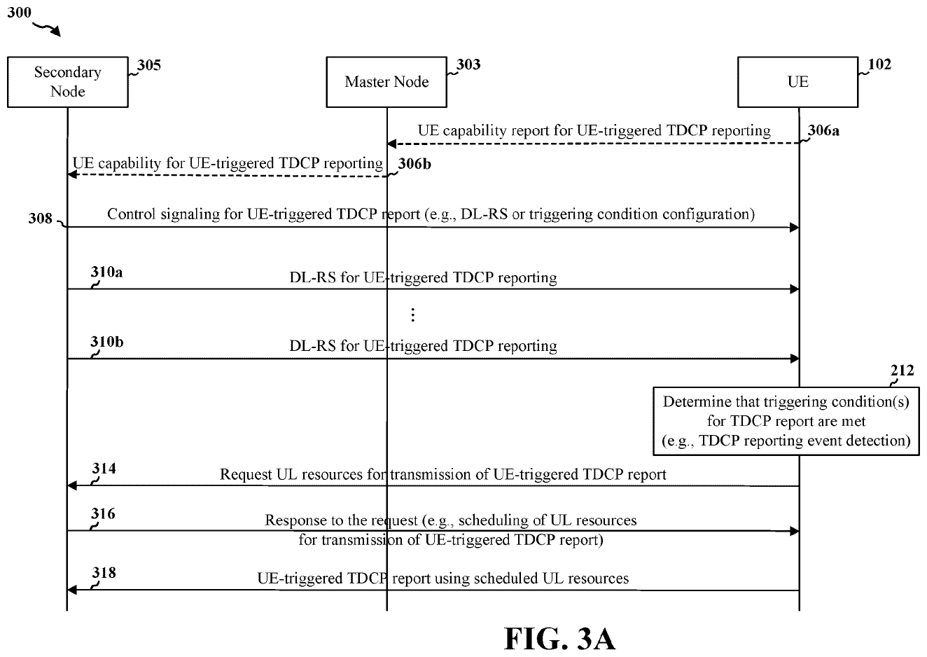

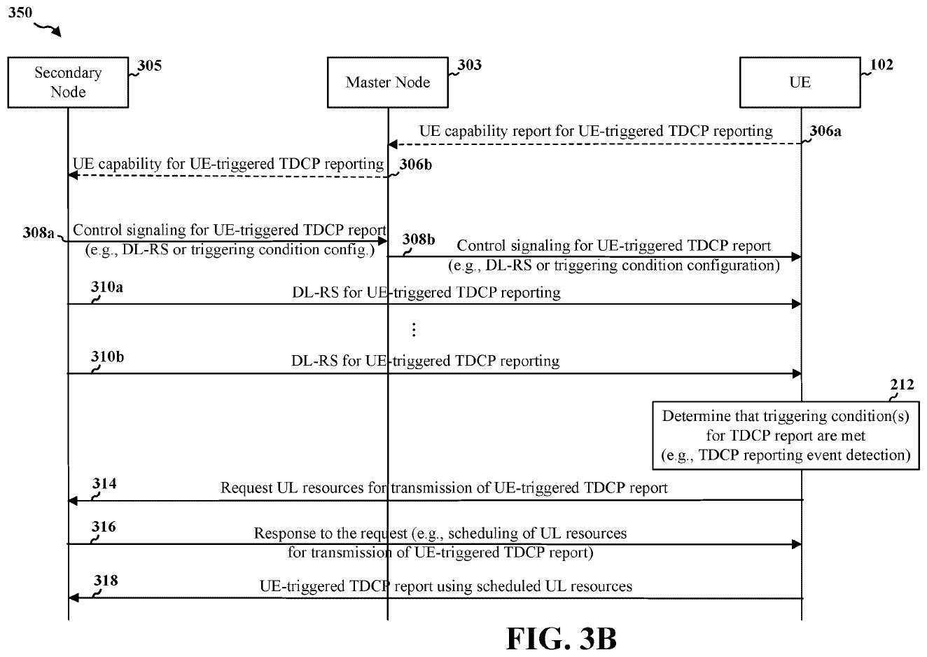

A UE-triggered TDCP report may be implemented to reduce the overhead associated with TDCP reporting procedures as well as the latency associated with indicating a TDCP status change. The UE-triggered TDCP report can be triggered based on a triggering condition. For example, the UE 102 might determine 212 that the triggering condition(s) for the TDCP report are met (e.g., TDCP reporting event detection), which might be determined through measurement of one or more DL-RSs received 210a-210b from the network entity 104. If the UE 102 determines 212 that the triggering condition(s) for the TDCP report are met, the UE 102 might transmit 214 a request for uplink resources for transmission of the UE-triggered TDCP report to the network entity 104. After the network entity 104 receives 214 the request from the UE 102, the network entity 104 may transmit 216 a response to the request (e.g., scheduling uplink resources for transmission of the UE-triggered TDCP report) that indicates how the UE 102 is to provide the TDCP report to the network entity 104. The UE 102 transmits 218 the UE-triggered TDCP report to the network entity 104 using the scheduled uplink resources indicated in the response received 216 from the network entity 104. In some examples, the response might trigger the UE 102 to transmit an aperiodic TDCP report. While FIG. 2 describes a TDCP report triggering procedure between a UE 102 and a single network entity 104, other architectures (e.g., as illustrated in FIGS. 3A-3B) can include signaling between multiple network entities.

FIGS. 3A-3B are signaling diagrams 300-350 that illustrate triggering procedures for TDCP reporting in dual-connectivity (DC) architectures. The signaling diagrams 300-350 include the UE 102, a master node 303, and a secondary node 305. The master node 303 and the secondary node 305 may also be referred to as network entities. In some examples, the secondary node can be referred to as a slave node.

In the signaling diagram 300, the UE 102 transmits 306a the UE capability report for UE-triggered TDCP reporting to the master node 303. The master node 303 then forwards/relays 306b the UE capability for the UE-triggered TDCP reporting to the secondary node 305. After the secondary node 305 receives 306b the UE capability for the UE-triggered TDCP reporting from the master node 306, the secondary node 305 may transmit 308 control signaling for the UE-triggered TDCP report directly to the UE 102 for the TDCP report to be triggered based on one or more DL-RSs received 310a-310b from the secondary node 305 as well as a triggering condition configuration. The UE 102 determines 212 that the triggering conditions for the TDCP report are met (e.g., TDCP reporting event detection), as described with respect to FIG. 2. However, rather than transmitting/receiving a request/response to a network entity associated with a non-DC architecture, as described with respect to FIG. 2, the UE 102 in the diagram 300 transmits 314 the request for uplink resources for transmission of the UE-triggered TDCP report to the secondary node 305 and receives 316, from the secondary node 305, the response to the request (e.g., scheduling of uplink resources for the transmission of the UE-triggered TDCP report). The UE 102 transmits 318 the UE-triggered TDCP report to the network entity 104 using the scheduled uplink resources indicated in the response received 316 from the network entity 104.

In some implementations, a triggering condition configuration configures a UE 102 for determining 212 and/or detecting trigger conditions that cause the UE 102 to generate and/or transmit 318 a TDCP report. A triggering condition configuration is configured at the UE 102 based on control signaling. The triggering condition configuration can include one or more reference values (e.g., threshold values) that are used by the UE 102 to: i) determine (or select) one or more triggering conditions and ii) determine 212 and/or detect that a triggering condition is met/satisfied. A given trigger condition is associated with, or corresponds to, a measurement value. For example, the UE 102 can acquire a measurement value(s) by measuring or otherwise obtaining UE parameters such as UE speed (including acceleration or velocity), Doppler spread (or shift), CSI-RS, or a combination of these. The UE 102 can generate the measurement values locally, acquire them from a remote source, or both. The UE 102 can compare a particular measurement value to a corresponding reference/threshold value to determine 212 or detect that a given triggering condition is satisfied. In some examples, a trigger condition is based on a particular event and a corresponding reference value for that event. For example, a trigger condition may be based on a UE velocity change that exceeds a first threshold, a TDCP change that exceeds a second threshold, a CSI (or CSI-RS) change that exceeds a third threshold, or a combination of these.

The elements of the signaling diagram 350 illustrated in FIG. 3B are similar to the elements described/illustrated in the signaling diagram 300 of FIG. 3A, except that the control signaling transmitted 308 in the signaling diagram 300 directly from the secondary node 305 to the UE 102 is forwarded/relayed 308b in the signaling diagram 350 by the master node 303. That is, the secondary node 305 transmits 308a the control signaling for the UE-triggered TDCP report based on the DL-RS and the triggering condition configuration to the master node 303, and the master node 303 forwards/relays 308a the control signaling for the UE-triggered TDCP report based on the DL-RS and the triggering condition configuration to the UE 102.

Referring again to FIG. 2, the network entity 104 may transmit 208 RRC signaling that indicates an RRC reconfiguration message or the network entity 104 may transmit a system information block (SIB), where the SIB can be a predefined SIB (e.g., SIBI) or a different SIB (e.g., SIB J, where J corresponds to an integer greater than 21). The UE 102 may indicate UE capabilities on a UE-triggered TDCP report. The indicated UE capabilities may correspond to whether the UE 102 supports the UE-triggered TDCP report, a maximum DL-RS for UE-triggered TDCP reporting, which may be counted per CC, per band, per band combination, and/or per UE, a maximum number of serving cells configured for UE-triggered TDCP reports, which may be counted per band, per band combination, and/or per UE, and whether the UE 102 supports a UE trigger condition for the TDCP report that is not based on a measurement value of a DL-RS. A UE acceleration, as measured by a different source (e.g., GPS), might be one example of a UE trigger condition for the TDCP report that is not based on one or more measurement values of DL-RSs. If the UE 102 supports the UE trigger condition for the TDCP report that is not based on one or more DL-RS measurement values, the UE 102 might perform TDCP reporting event detection based on one or more sensors/sensor outputs (e.g., based on a sensor for UE speed/velocity or acceleration detection). In some examples, the UE's moving speed (or velocity), acceleration, position, or direction of movement may be determined relative to another device within a network.

The network entity 104 may transmit 208 the control signaling for the UE-triggered TDCP report via higher layer signaling, such as the RRC signaling. The control signaling can indicate one or more of TDCP reporting event selection techniques, at least one DL-RS for the UE-triggered TDCP report, an interval for TDCP reporting event detection, a number of detected TDCP reporting events for sending a request for transmission of the UE-triggered TDCP report, a maximum number of retransmissions of the request, a time window for detection of a response to the request, an uplink resource for the request, or a downlink resource for the response to the request. The network entity 104 may indicate the RRC parameters per bandwidth part (BWP), per serving cell, per cell group, or per UE.

TDCP reporting event selection corresponds to an indicated event for the UE 102 to identify for triggering the TDCP report. For example, a first TDCP reporting event may include a UE speed change above a first threshold, where a reference UE speed for the UE 102 is measured at a first reference time instance and the first threshold is predefined or configured via RRC signaling from the network entity 104. A second TDCP reporting event may include a TDCP change above a second threshold, where a reference TDCP correspond to a TDCP reported at a second reference time instance and the second threshold is predefined or configured via the RRC signaling from the network entity 104. A third TDCP reporting event may include a CSI change above a third threshold, where a reference CSI corresponds to a CSI reported at a third reference time instance and the third threshold is predefined or configured via the RRC signaling from the network entity 104. The first reference time instance may be a time instance associated with a most recent TDCP report, a most recent CSI, a first DL-RS for a most recent TDCP measurement and report, or a second DL-RS for a most recent CSI measurement and report. The second reference time instance may be a time instance associated with the most recent TDCP measurement or report. The third reference time instance may be a time instance associated with the most recent CSI measurement or report. If the network entity 104 indicates the TDCP report event selection through RRC signaling, at least two TDCP reporting events can be selected for triggering the TDCP report.

If the TDCP reporting event corresponds to the TDCP change being above the second threshold, the TDCP change can be based on a Doppler shift offset or a Doppler spread offset. In examples, the TDCP change can be based on the channel correlation change for a top K strongest paths, where K corresponds to an integer above 1 and is predefined or configured via the RRC signaling from the network entity 104. The TDCP change can be calculated based on:

$$d = \frac{1}{K} {\sum }_{j = 1}^{K} \frac{\vert {{c}_{1} ( j )}^{H} {c}_{2} ( j ) \vert}{\vert {c}_{1} ( j ) \vert \vert {c}_{2} ( j ) \vert}$$

where c₁ corresponds to the reference channel correlation and c₂ corresponds to the measured channel correlation. The second threshold can be based on a channel correlation change that might be within the range of (0, 1).

If the TDCP reporting event corresponds to the CSI change being above the third threshold, the CSI change can be based on a cosine similarity between a wideband channel eigenvector and a reference channel eigenvector, which can be calculated based on:

$$e = \frac{1}{R} {\sum }_{j = 1}^{R} \frac{‖ {( {v}_{1}^{j} )}^{H} {v}_{2}^{j} ‖}{‖ {v}_{1}^{j} ‖ ‖ {v}_{2}^{j} ‖}$$

where R corresponds to a rank of the eigenvector,

$${v}_{1}^{j}$$

corresponds to a j^{th} row of the reference eigenvector, and

$${v}_{2}^{j}$$

corresponds to the j^{th} row of a measured eigenvector. The reference eigenvector is based on the CSI reported at the third reference time instance. The third threshold can be based on the cosine similarity being within the range of (0, 1).

If the TDCP reporting event corresponds to either the TDCP change being above the second threshold or the CSI change being above the third threshold, the network entity 104 and the UE 102 might determine, based on a measurement, that the one or more DL-RSs for the TDCP reporting corresponds to a number of CSI processing units. A CSI processing unit might be occupied from a first symbol or a last symbol of the one or more DL-RSs associated with the TDCP reporting until S symbols after the last symbol of the one or more DL-RSs associated with the TDCP reporting, where S is predefined or indicated in the UE capability report.

The network entity 104 may configure at least one of CSI-RS resources or at least one TRS for TDCP reporting. The resources might be for TDCP reporting of a beam or a TRP. If the network entity 104 does not configure the CSI-RS/TRS for TDCP reporting, the CSI-RS/TRS configured in a transmission configuration indicator (TCI) for a physical downlink shared channel (PDSCH) can be used for the TDCP reporting. The CSI-RS/TRS may be periodic.

The network entity 104 may configure the interval for TDCP reporting event detection and a number of detected TDCP reporting event for the UE 102 to send 214 the request for uplink resources for transmission of the UE-triggered TDCP report to the network entity 104. After receiving 208 the control signaling from the network entity 104, the UE 102 can start a counter for TDCP reporting event detection. At each interval, the UE 102 detects whether the TDCP reporting event is identified. If the UE 102 identifies the TDCP reporting event, the UE 102 increases the counter by 1 count. If the counter reaches the number of detected TDCP reporting events for sending 214 the request to the network entity 104, the UE 102 transmits 214 the request to the network entity 104. The counter can be reset if the UE 102 receives control signaling that triggers the UE 102 to transmit 218 the TDCP report, or if the UE 102 transmits 214 the request to the network entity 104, or if the UE 102 receives 216 the response to the request, or if the UE 102 does not detect a TDCP reporting event within a detection interval. The number of detected TDCP reporting events for sending 214 the request to the network entity 104 may be predefined as 1, in some examples. In other examples, the interval for TDCP reporting event detection may be determined based on a minimum, maximum, or average periodicity of the DL-RSs transmitted 210a-210b for the TDCP reporting.

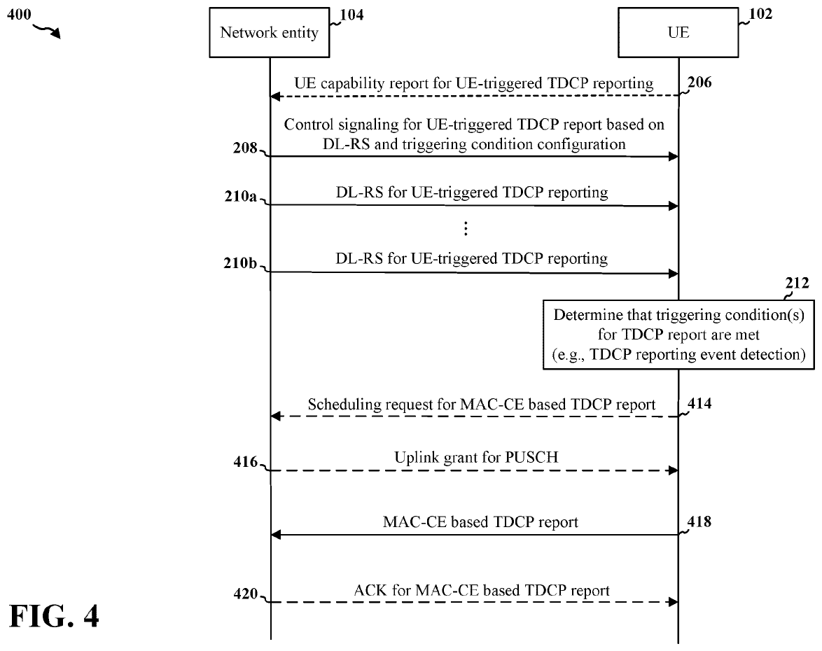

The network entity 104 may configure a maximum number of retransmissions of the request for transmission of the UE-triggered TDCP report and a time window for detection of the response to the request. After sending 214 the request to the network entity 104, the UE 102 can begin scanning for the response from the network entity 104. If the UE 102 does not detect a response from the network entity 104 within the configured time window, the UE 102 can retransmit the request. The network entity 104 may also configure at least one uplink resource for the UE 102 to send 214 the request to the network entity 104. The uplink resource may be a PUCCH resource (e.g. a scheduling request (SR) configuration), a configured-grant PUSCH resource, or a PRACH resource. In further examples, the network entity 104 may configure at least one dedicated search space (SS) or at least one dedicated control resource set (CORESET) for the network entity 104 to transmit 216 the response to the UE 102. FIGS. 2 and 3A-3B illustrate a UE-triggered TDCP report on uplink resources. FIGS. 4-6 illustrate different types of uplink resources that the UE 102 may use for transmission of UE-triggered TDCP reports.

FIG. 4 is a signaling diagram 400 that illustrates a TDCP report transmitted via MAC-CE. Elements 206, 208, 210a-210b, and 212 of FIG. 4 have already been described with respect to FIG. 2.

The MAC-CE may be associated with at least one of serving cell index(es) or serving cell group index(es) for the TDCP report, BWP index(es) for the TDCP report, DL-RS index(es) for the TDCP report or a CSI report configuration identifier (ID), or a TDCP for the one or more DL-RSs. The network entity 104 may configure the UE-triggered TDCP report per serving cell group. For each serving cell group, the network entity 104 may configure at least one DL-RS for the TDCP report. The UE 102 can report the serving cell group index in the MAC-CE based on the UE 102 detecting the TDCP reporting event for the UE-triggered TDCP report and the TDCP for the configured one or more DL-RSs for the UE-triggered TDCP report.

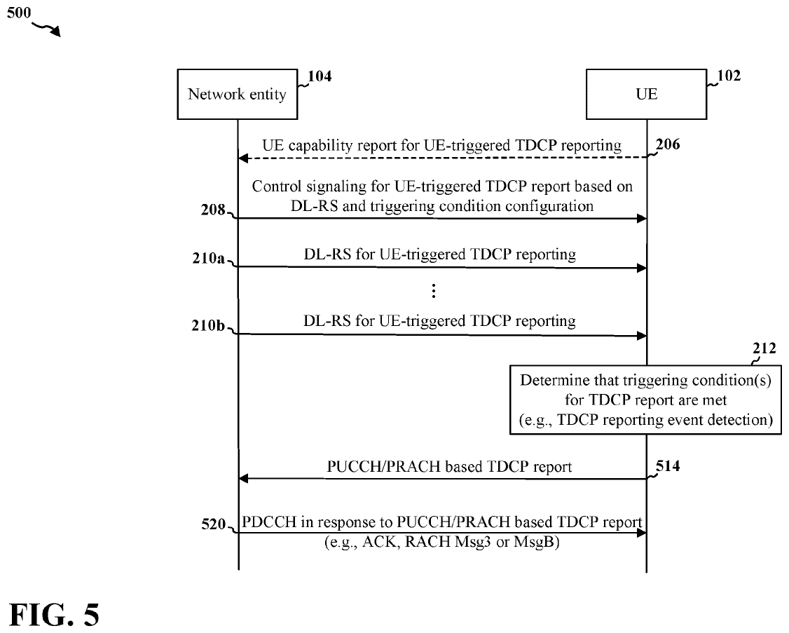

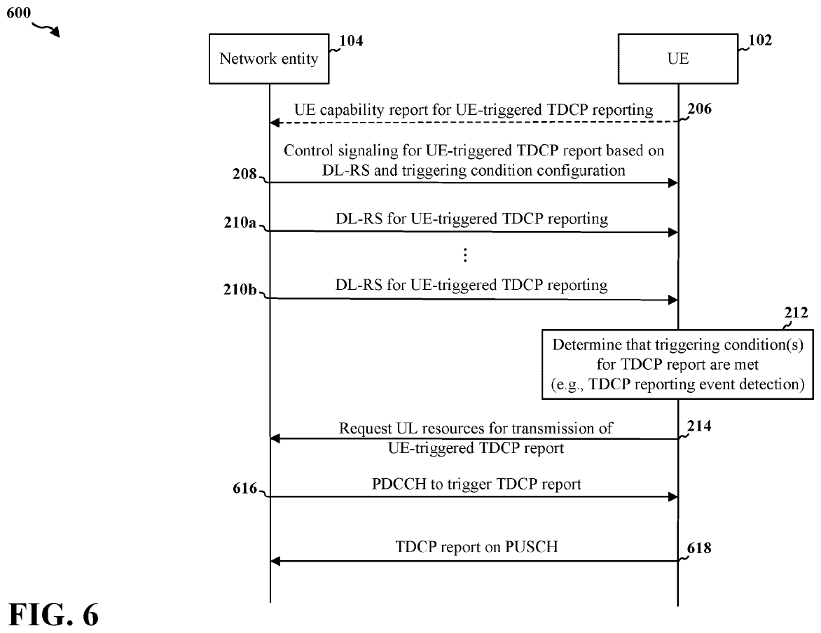

The UE 102 may transmit 418 a MAC-CE based TDCP report to the network entity 104 on configured-grant based PUSCH resources, and the network entity 104 may transmit 420 acknowledgment/negative acknowledgment (ACK/NACK) feedback to the UE 102 responsive to receiving 418 the MAC-CE based TDCP report from the UE 102. For example, the network entity 104 can transmit 420 an ACK for the MAC-CE based TDCP report, if the network entity 104 is able to decode the MAC-CE based TDCP report received 418 from the UE 102. Alternatively, the UE 102 may transmit 414 a scheduling request (SR) for the MAC-CE based TDCP report to the network entity 104 to request uplink resources for the MAC-CE transmission. The network entity 104 can transmit 416, to the UE 102, an uplink grant for a PUSCH based on the SR received 414 from the UE 102. In examples, the network entity 104 may configure a dedicated SR for the MAC-CE based TDCP report. Alternatively, the network entity 104 might not configure the dedicated SR, and the UE 102 may request the uplink resources via a contention-based PRACH or a SR configured for another purpose (e.g. a SR for beam failure recovery (BFR) or other SR). A response to the MAC-CE based request can be on a PDCCH that schedules a PUSCH transmission for a same hybrid automatic repeat request (HARQ) process as used for the MAC-CE report. While FIG. 4 illustrates transmission of the TDCP report to the network entity 104 via MAC-CE, FIGS. 5-6 further illustrate that TDCP reports can also be transmitted to the network entity on physical uplink channels.

FIG. 5 is a signaling diagram 500 that illustrates a one-step TDCP report transmission on PUCCH resources. Elements 206, 208, 210a-210b, and 212 of FIG. 5 have already been described with respect to FIG. 2.

The UE 102 may transmit the request for the transmission of the UE-triggered TDCP report on a PUCCH. The network entity 104 may configure one or more PUCCH resources, where different PUCCH resources may correspond to different serving cells, serving cell groups, or TRPs. The UE 102 may report the TDCP to the network entity 104 via the PUCCH. The PUCCH can include at least one of serving cell index(es) for the TDCP report, serving cell group index(es) for the TDCP report, BWP index(es) for the TDCP report, DL-RS index(es) for the TDCP report or CSI report configuration ID(s), or a TDCP for the reported DL-RSs.

The network entity 104 may configure the UE-triggered TDCP report per serving cell group. For each serving cell group, the network entity 104 can configure at least one DL-RS for the TDCP report. The UE 102 may report the serving cell group index in the PUCCH, where the UE 102 might identify the TDCP reporting event for the UE-triggered TDCP report and the TDCP for the configured DL-RSs for the UE-triggered TDCP report.

The UE 102 can transmit 514 a PUCCH/PRACH based TDCP report to the network entity 104. The UE 102 may report the TDCP for the configured or reported DL-RSs in the PUCCH/PRACH transmitted 526 to the network entity 104. After receiving 526 the PUCCH/PRACH from the UE 102, the network entity 104 might transmit 520, to the UE 102, a PDCCH (e.g., ACK, random access channel (RACH) message (Msg) 3 or MsgB) in response to the PUCCH/PRACH based TDCP report. In examples, the network entity 104 can transmit 520 the PDCCH (e.g., ACK, RACH Msg3 or MsgB) to the UE 102 in a configured dedicated SS/CORESET. In further examples, the network entity 104 can transmit 520 the PDCCH (e.g., ACK, RACH Msg3 or MsgB) to the UE 102 via a dedicated configured radio network temporary identifier (RNTI).

FIG. 6 is a signaling diagram 600 that illustrates a two-step TDCP report transmission on PUSCH resources. Elements 206, 208, 210a-210b, 212, and 214 of FIG. 6 have already been described with respect to FIG. 2.

The network entity 104 may configure one or more PUCCH/PRACH resources, where different PUCCH/PRACH resources correspond to different serving cells, different serving cell groups, different TRPs, or different CSI report configurations. For PUCCH based transmissions, the PUCCH may indicate at least one of serving cell index(es) for the TDCP report, serving cell group index(es) for the TDCP report, BWP index(es) for the TDCP report, or CSI report configuration ID(s) for the TDCP report. In examples, the network entity 104 may configure the UE-triggered TDCP report per serving cell group. For each serving cell group, the network entity 104 may configure one PUCCH/PRACH resource. The UE 102 may transmit the corresponding PUCCH/PRACH for the serving cell group index, if the UE 102 detects the TDCP reporting event for the UE-triggered TDCP report.

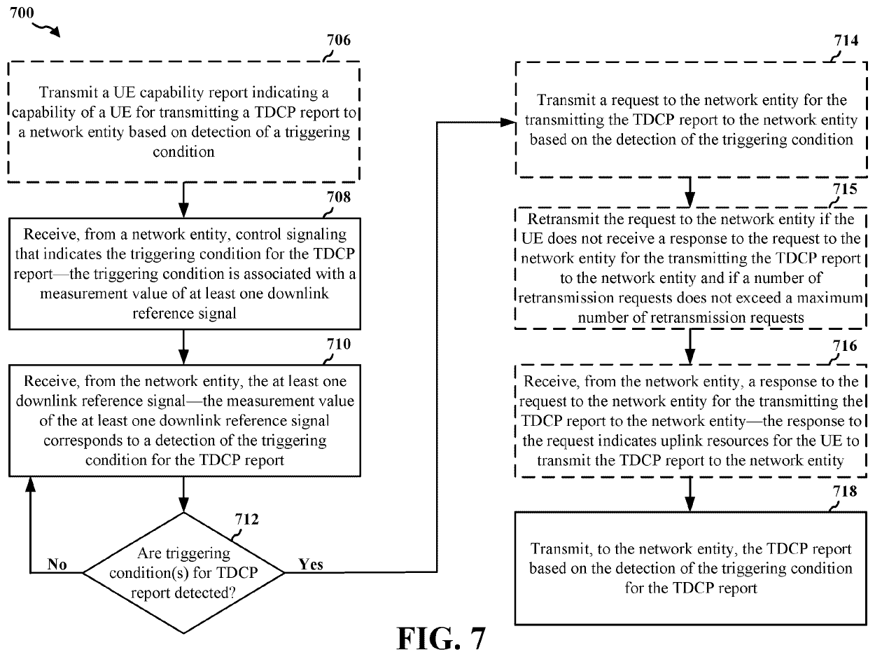

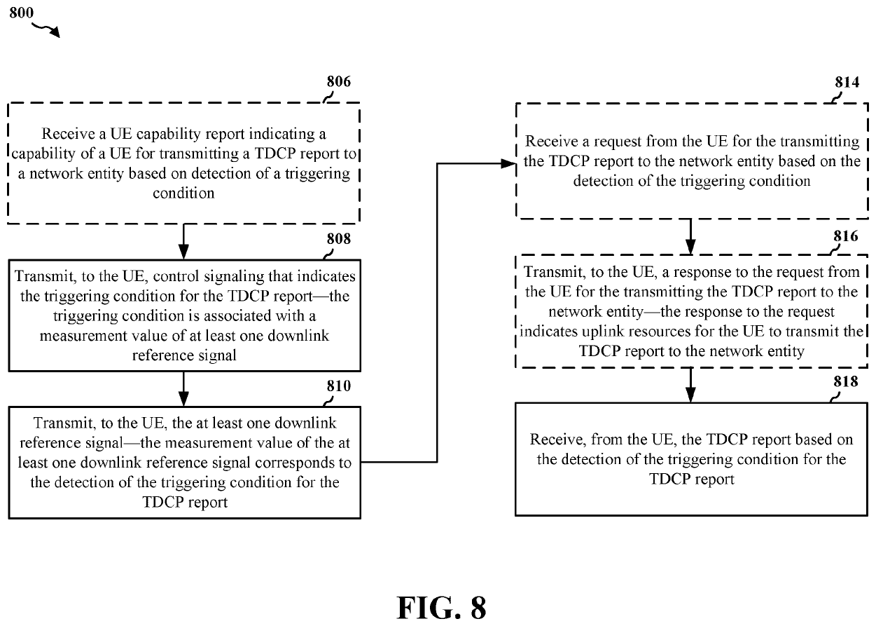

The UE 102 may transmit 214 the request to the network entity 104 by PUCCH/PRACH. That is, the UE 102 may transmit 214 the request at corresponding PUCCH/PRACH resources. After receiving 214 the PUCCH/PRACH from the UE 102, the network entity 104 might determine a CSI report configuration for the TDCP report. The network entity 104 might transmit 616 a PDCCH to the UE 102 to trigger the TDCP report from the UE 102 and configure the CSI report configuration. After receiving 616 control signaling, such as the PDCCH, to trigger the TDCP report and the CSI report configuration for the TDCP report, the UE 102 may measure and report TDCP based on TRS configured in the CSI report configuration. For example, the UE 102 can transmit 618 the TDCP report on PUSCH to the network entity 104. FIGS. 7-8 show methods for implementing one or more aspects of FIGS. 2-6. In particular, FIG. 7 shows an implementation by the UE 102 of the one or more aspects of FIGS. 2-6. FIG. 8 shows an implementation by the network entity 104 of the one or more aspects of FIGS. 2-6.

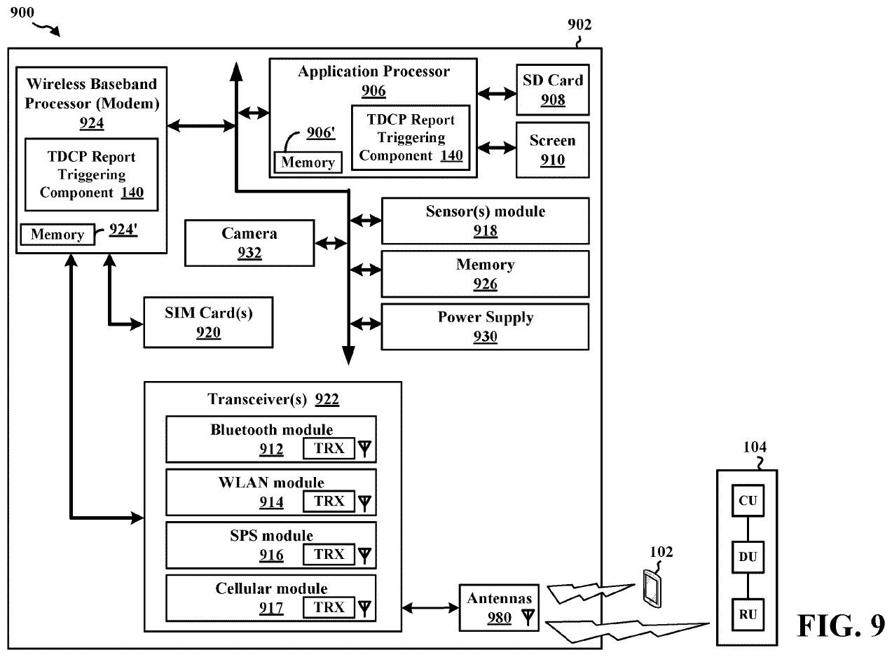

FIG. 7 illustrates a flowchart 700 of a method of wireless communication at a UE. With reference to FIGS. 1 and 9, the method may be performed by the UE 102, the UE apparatus 902, etc., which may include the memory 924′ and which may correspond to the entire UE 102 or the UE apparatus 902, or a component of the UE 102 or the UE apparatus 902, such as the wireless baseband processor 924, and/or the application processor 906.

The UE 102 transmits 706 a UE capability report indicating a capability of a UE for transmitting a TDCP report to a network entity based on detection of a triggering condition. For example, referring to FIG. 2, the UE 102 transmits 206 a UE capability report for UE-triggered TDCP reporting to the network entity 104. Referring to FIGS. 3A-3B, the UE 102 transmits 306a a UE capability report for UE-triggered TDCP reporting to the master node 303, which forwards/relays 306b an indication of the UE capability to the secondary node 305.

The UE 102 receives 708, from a network entity, control signaling that indicates the triggering condition for the TDCP report—the triggering condition is associated with a measurement value of at least one downlink reference signal. For example, referring to FIG. 2, the UE 102 receives 208 control signaling from the network entity 104 for the UE-triggered TDCP report. Referring to FIG. 3A, the UE 102 receives 308 control signaling from the secondary node 305 for the UE-triggered TDCP report. Referring to FIG. 3B, the UE 102 receives 308b control signaling from the master node 303 for the UE-triggered TDCP report, which is forwarded/relayed from the secondary node 305. The control signaling may correspond to a downlink reference signal configuration, a triggering condition configuration, etc.

The UE 102 receives 710, from the network entity, the at least one downlink reference signal—the measurement value of the at least one downlink reference signal corresponds to a detection of the triggering condition for the TDCP report. For example, referring to FIG. 2, the UE 102 receives 210a-210b downlink reference signals from the network entity 104 for the UE-triggered TDCP reporting. Referring to FIGS. 3A-3B, the UE 102 receives 310a-310b downlink reference signals from the secondary node 305 for the UE-triggered TDCP reporting.

The UE 102 determines 712 whether triggering condition(s) for the TDCP report are detected, including whether a particular triggering condition is met/satisfied. For example, referring to FIG. 2, the UE 102 determines 212 that triggering condition(s) for the TDCP report are met, which might be based on a TDCP reporting event detection associated with a measurement of the downlink reference signals received 210a-210b from the network entity 104, which may correspond to the secondary node 305 in some example. If the UE 102 determines 712 that the triggering condition(s) for the TDCP report are not detected and/or met, the UE 102 proceeds to further receive 710 the at least one downlink reference signal from the network entity 104.

If the UE 102 detects/determines 712 that the triggering condition(s) for the TDCP report are present (i.e., detected and/or met), the UE 102 transmits 714 a request to the network entity to obtain a resource for transmitting the TDCP report to the network entity based on the detection of the triggering condition. For example, referring to FIG. 2, the UE 102 transmits 214 the request to the network entity 104 for uplink resources for transmission of the UE-triggered TDCP report to the network entity 104. Referring to FIGS. 3A-3B, the UE 102 transmits 314 the request to the secondary node 305 for uplink resources for transmission of the UE-triggered TDCP report to the secondary node 305. Referring to FIG. 4, the request transmitted 414 to the network entity 104 may correspond to a scheduling request for a MAC-CE based TDCP report.

The UE 102 retransmits 715 the request to the network entity if the UE does not receive a response to the request to the network entity for the transmitting the TDCP report to the network entity and if a number of retransmission requests does not exceed a maximum number of retransmission requests. For example, referring to FIG. 2, the request transmitted 214 to the network entity 104 by the UE 102 may be a retransmission of the request to the network entity 104 for the uplink resources.

The UE 102 receives 716, from the network entity, a response to the request to the network entity for the transmission of the TDCP report to the network entity—the response to the request indicates uplink resources for the UE to transmit the TDCP report to the network entity. For example, referring to FIG. 2, the UE 102 receives 216 a response from the network entity 104 to the request for the transmission of the UE-triggered TDCP report. Referring to FIGS. 3A-3B, the UE 102 receives 316 a response from the secondary node 305 to the request for the transmission of the UE-triggered TDCP report. The response may correspond to a scheduling of uplink resources for transmission 218 of the UE-triggered TDCP report to the network entity 104. Referring to FIG. 4, the response may correspond to reception 416 of an uplink grant for a PUSCH. Referring to FIG. 6, the response may correspond to reception 616 of a PDCCH that triggers the TDCP report from the UE 102.

The UE 102 transmits 718, to the network entity, the TDCP report based on the detection of the triggering condition for the TDCP report. For example, referring to FIG. 2, the UE 102 transmits 218, based on the determination 212 that the triggering condition(s) are met, the UE-triggered TDCP report to the network entity 104 using scheduled uplink resources. Referring to FIGS. 3A-3B, the UE 102 transmits 318, based on the determination 212 that the triggering condition(s) are met, the UE-triggered TDCP report to the secondary node 305 using scheduled uplink resources. Referring to FIGS. 4-6, the UE 102 transmits 418/514/618 the TDCP report to the network entity 104 via MAC-CE, PUCCH, PRACH, or PUSCH. FIG. 7 describes a method from a UE-side of a wireless communication link, whereas FIG. 8 describes a method from a network-side of the wireless communication link.

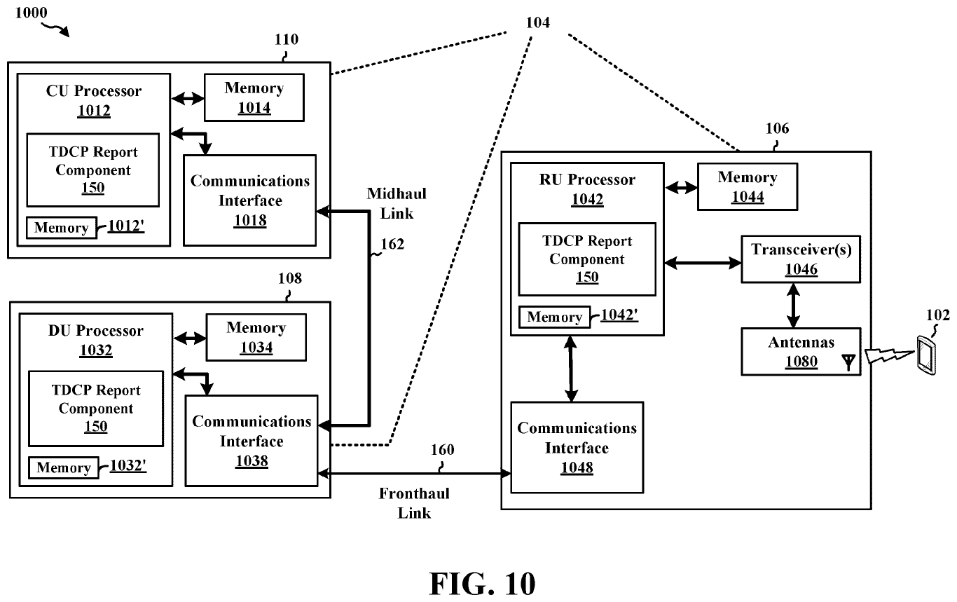

FIG. 8 is a flowchart 800 of a method of wireless communication at a network entity. With reference to FIGS. 1 and 10, the method may be performed by the base station 104 or one or more network entities of the base station 104, which may correspond to the RU 106, the DU 108, the CU 110, an RU processor 1042, a DU processor 1032, a CU processor 1012, etc. The base station 104 or the one or more network entities of the base station 104 may include the memory 1012′/1032′/1042′, which may correspond to an entirety of the one or more network entities or the base station 104, or a component of the one or more network entities or the base station 104, such as the RU processor 1042, the DU processor 1032, or the CU processor 1012.

The base station 104 or the one or more network entities of the base station 104 receives 806 a UE capability report indicating a capability of a UE for transmitting a TDCP report to a network entity based on detection of a triggering condition. For example, referring to FIG. 2, the network entity 104 receives 206 a UE capability report for UE-triggered TDCP reporting from the UE 102. Referring to FIGS. 3A-3B, the master node 303 receives 306a a UE capability report for UE-triggered TDCP reporting from the UE 102, such that the master node 303 may forward/relay 306b an indication of the UE capability to the secondary node 305.

The base station 104 or the one or more network entities of the base station 104 transmits 808, to the UE, control signaling that indicates the triggering condition for the TDCP report—the triggering condition is associated with a measurement value of at least one downlink reference signal. For example, referring to FIG. 2, the network entity 104 transmits 208 control signaling to the UE 102 for the UE-triggered TDCP report. Referring to FIG. 3A, secondary node 305 transmits 308 control signaling to the UE 102 for the UE-triggered TDCP report. Referring to FIG. 3B, the secondary node 305 transmits 308a control signaling to the master node 303 for the UE-triggered TDCP report, which is forwarded/relayed 308b to the UE 102. The control signaling may correspond to a downlink reference signal configuration, a triggering condition configuration, etc.

The base station 104 or the one or more network entities of the base station 104 transmits 810, to the UE, the at least one downlink reference signal—the measurement value of the at least one downlink reference signal corresponds to the detection of the triggering condition for the TDCP report. For example, referring to FIG. 2, the network entity 104 transmits 210a-210b downlink reference signals to the UE 102 for the UE-triggered TDCP reporting. Referring to FIGS. 3A-3B, the secondary node 305 transmits 310a-310b downlink reference signals to the UE 102 for the UE-triggered TDCP reporting.

The base station 104 or the one or more network entities of the base station 104 receives 814 a request from the UE for the transmitting the TDCP report to the network entity based on the detection of the triggering condition. For example, referring to FIG. 2, the network entity 104 receives 214 the request from the UE 102 for uplink resources for transmission of the UE-triggered TDCP report from the UE 102. Referring to FIGS. 3A-3B, the secondary node 305 receives 314 the request from the UE 102 for uplink resources for transmission of the UE-triggered TDCP report from the UE 102. Referring to FIG. 4, the request received 414 from the UE 102 may correspond to a scheduling request for a MAC-CE based TDCP report.

The base station 104 or the one or more network entities of the base station 104 transmits 816, to the UE, a response to the request from the UE for the transmitting the TDCP report to the network entity—the response to the request indicates uplink resources for the UE to transmit the TDCP report to the network entity. For example, referring to FIG. 2, the network entity 104 transmits 216 a response to the UE 102 to the request for the transmission of the UE-triggered TDCP report. Referring to FIGS. 3A-3B, the secondary node 305 transmits 316 a response to the UE 102 to the request for the transmission of the UE-triggered TDCP report. The response may correspond to a scheduling of uplink resources for reception 218 of the UE-triggered TDCP report from the UE 102. Referring to FIG. 4, the response may correspond to transmission 416 of an uplink grant for a PUSCH. Referring to FIG. 6, the response may correspond to transmission 616 of a PDCCH that triggers the TDCP report from the UE 102.

The base station 104 or the one or more network entities of the base station 104 receives 818, from the UE, the TDCP report based on the detection of the triggering condition for the TDCP report. For example, referring to FIG. 2, the network entity 104 receives 218 the UE-triggered TDCP report from the UE 102 over scheduled uplink resources. Referring to FIGS. 3A-3B, the secondary node 305 receives 318 the UE-triggered TDCP report from the UE 102 over scheduled uplink resources. Referring to FIGS. 4-6, the network entity 104 receives 418/514/618 the TDCP report from the UE 102 via MAC-CE, PUCCH, PRACH, or PUSCH. A UE apparatus 902, as described in FIG. 9, may perform the method of flowchart 700. The base station 104 or the one or more network entities of the base station 104, as described in FIG. 10, may perform the method of flowchart 800.

FIG. 9 is a diagram 900 illustrating an example of a hardware implementation for a UE apparatus 902. The apparatus 902 may be the UE 102, a component of the UE, or may implement UE functionality. In some aspects, the apparatus 902 may include a wireless baseband processor 924 (also referred to as a modem) coupled to one or more transceivers 922 (e.g., wireless RF transceiver). The wireless baseband processor 924 may include on-chip memory 924′. In some aspects, the apparatus 902 may further include one or more subscriber identity modules (SIM) cards 920 and an application processor 906 coupled to a secure digital (SD) card 908 and a screen 910, The application processor 906 may include on-chip memory 906′.

The apparatus 902 may further include a Bluetooth module 912, a WLAN module 914, an SPS module 916 (e.g., GNSS module), and a cellular module 917 within the one or more transceivers 922. The Bluetooth module 912, the WLAN module 914, the SPS module 916, and the cellular module 917 may include an on-chip transceiver (TRX) (or in some cases, just a receiver (RX)). The Bluetooth module 912, the WLAN module 914, the SPS module 916, and the cellular module 917 may include their own dedicated antennas and/or utilize the antennas 980 for communication. The apparatus 902 may further include one or more sensor modules 918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 926, a power supply 930, and/or a camera 932.

The wireless baseband processor 924 communicates through the transceiver(s) 922 via one or more antennas 980 with another UE 102 and/or with an RU associated with a network entity 104. The wireless baseband processor 924 and the application processor 906 may each include a computer-readable medium/memory 924′, 906′, respectively. The additional modules of memory 926 may also be considered a computer-readable medium/memory. Each computer-readable medium/memory 924′, 906′, 926 may be non-transitory. The wireless baseband processor 924 and the application processor 906 are each responsible for general processing, including the execution of software stored on the computer-readable medium/memory. The software, when executed by the wireless baseband processor 924/application processor 906, causes the wireless baseband processor 924/application processor 906 to perform the various functions described. The computer-readable medium/memory may also be used for storing data that is manipulated by the wireless baseband processor 924/application processor 906 when executing software. The wireless baseband processor 924/application processor 906 may be a component of the UE 102. The apparatus 902 may be a processor chip (modem and/or application) and include just the wireless baseband processor 924 and/or the application processor 906, and in another configuration, the apparatus 902 may be the entire UE 102 and include the additional modules of the apparatus 902.

As discussed, the TDCP report triggering component 140 is configured to receive, from a network entity, control signaling that indicates a triggering condition for a TDCP report, where the triggering condition is associated with a measurement value of at least one downlink reference signal; receive, from the network entity, the at least one downlink reference signal, where the measurement value of the at least one downlink reference signal corresponds to a detection of the triggering condition for the TDCP report; and transmit, to the network entity, the TDCP report based on the detection of the triggering condition for the TDCP report. The TDCP report triggering component 140 may be within the wireless baseband processor 924, the application processor 906, or both the wireless baseband processor 924 and the application processor 906. The TDCP report triggering component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 902 may include a variety of components configured for various functions. In one configuration, the apparatus 902, and in particular the wireless baseband processor 924 and/or the application processor 906, includes means for receiving, from a network entity, control signaling that indicates a triggering condition for a TDCP report, where the triggering condition is associated with a measurement value of at least one downlink reference signal; means for receiving, from the network entity, the at least one downlink reference signal, where the measurement value of the at least one downlink reference signal corresponds to a detection of the triggering condition for the TDCP report; and means for transmitting, to the network entity, the TDCP report based on the detection of the triggering condition for the TDCP report. The apparatus 902 further includes means for transmitting a UE capability report indicating a capability of the UE for the transmitting the TDCP report to the network entity based on the detection of the triggering condition. The apparatus 902 further includes means for transmitting a request to the network entity for the transmitting the TDCP report to the network entity based on the detection of the triggering condition. The apparatus 902 further includes means for retransmitting the request to the network entity if the UE does not receive a response to the request to the network entity for the transmitting the TDCP report to the network entity and if a number of retransmission requests does not exceed a maximum number of retransmission requests. The apparatus 902 further includes means for receiving, from the network entity, the response to the request to the network entity for the transmitting the TDCP report to the network entity, where the response to the request indicates uplink resources for the UE to transmit the TDCP report to the network entity. The apparatus 902 further includes means for receiving DCI that schedules a PUSCH transmission for the transmitting the TDCP report to the network entity over the MAC-CE. The means for transmitting the TDCP report to the network entity occurs over the PUCCH, is further configured to: receive ACK/NACK feedback in at least one of a dedicated search space or a CORESET in response to the transmitting the TDCP report to the network entity over the PUCCH. The means may be the TDCP report triggering component 140 of the apparatus 902 configured to perform the functions recited by the means.

FIG. 10 is a diagram 1000 illustrating an example of a hardware implementation for one or more network entities 104. The one or more network entities 104 may be a BS, a component of a BS, or may implement BS functionality. The one or more network entities 104 may include at least one of a CU 1010, a DU 1030, or an RU 1040. For example, the component 199 may sit at the one or more network entities 104, such as the CU 1010; both the CU 1010 and the DU 1030; each of the CU 1010, the DU 1030, and the RU 1040; the DU 1030; both the DU 1030 and the RU 1040; or the RU 1040.

The CU 1010 may include a CU processor 1012. The CU processor 1012 may include on-chip memory 1012′. In some aspects, the CU 1010 may further include additional memory modules 1014 and a communications interface 1018. The CU 1010 communicates with the DU 1030 through a midhaul link. 162, such as an F1 interface. The DU 1030 may include a DU processor 1032. The DU processor 1032 may include on-chip memory 1032′. In some aspects, the DU 1030 may further include additional memory modules 1034 and a communications interface 1038. The DU 1030 communicates with the RU 1040 through a fronthaul link 160. The RU 1040 may include an RU processor 1042. The RU processor 1042 may include on-chip memory 1042′. In some aspects, the RU 1040 may further include additional memory modules 1044, one or more transceivers 1046, antennas 1080, and a communications interface 1048. The RU 1040 communicates wirelessly with the UE 102.

The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed, the TDCP report component 150 is configured to: transmit, to a UE, control signaling that indicates a triggering condition for a TDCP report, where the triggering condition is associated with a measurement value of at least one downlink reference signal; transmit, to the UE, the at least one downlink reference signal, where the measurement value of the at least one downlink reference signal corresponds to a detection of the triggering condition for the TDCP report; and receive, from the UE, the TDCP report based on the detection of the triggering condition for the TDCP report. The TDCP report component 150 may be within one or more processors of one or more of the CU 1010, DU 1030, and the RU 1040. The TDCP report component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a UE, control signaling that indicates a triggering condition for a TDCP report, where the triggering condition is associated with a measurement value of at least one downlink reference signal; means for transmitting, to the UE, the at least one downlink reference signal, where the measurement value of the at least one downlink reference signal corresponds to a detection of the triggering condition for the TDCP report; and means for receiving, from the UE, the TDCP report based on the detection of the triggering condition for the TDCP report. The network entities 104 further include means for receiving a UE capability report indicating a capability of the UE for transmitting the TDCP report to the network entity based on the detection of the triggering condition. The network entities 104 further include means for receiving a request from the UE for the transmission of the TDCP report to the network entity based on the detection of the triggering condition. The network entities 104 further include means for transmitting, to the UE, the response to the request from the UE for the transmission of the TDCP report from the UE, where the response to the request indicates uplink resources for the UE to transmit the TDCP report to the network entity. The network entities 104 further include means for configuring resources for the at least one of the PUCCH or the PRACH based on RRC signaling, and where different resources of the resources correspond to at least one of different serving cells or different CSI report configurations. The network entities 104 further include means for transmitting DCI that schedules a PUSCH transmission for the receiving the TDCP report from the UE over the MAC-CE. The means for the receiving the TDCP report from the UE over the PUCCH, is further configured to: transmit ACK/NACK feedback in at least one of a dedicated search space or a CORESET in response to the receiving the TDCP report from the UE over the PUCCH. The means may be the TDCP report component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, control signaling that indicates a triggering condition for a TDCP report; receiving, from the network entity, the at least one downlink reference signal, and includes that a measurement value for at least one of UE motion or the at least one downlink reference signal is used for detection of a triggering condition for the TDCP report; and transmitting, to the network entity, the TDCP report based on the detection of the triggering condition for the TDCP report.

Example 2 may be combined with example 1 and further includes transmitting a UE capability report indicating a capability of the UE for transmitting the TDCP report to the network entity based on the detection of the triggering condition.

Example 3 may be combined with example 2 and includes that the UE capability report indicates at least one of: whether the UE supports the transmitting the TDCP report to the network entity, a property of the at least one downlink reference signal for the detection of the triggering condition for the TDCP report, or a maximum number of serving cells for the transmitting of the TDCP report.

Example 4 may be combined with any of examples 1-3 and further includes transmitting a request to the network entity for a resource, the resource is for transmitting the TDCP report to the network entity based on the detection of the triggering condition.

Example 5 may be combined with example 4 and further includes retransmitting the request to the network entity if the UE does not receive a response to the request to the network entity for the resource for transmitting the TDCP report to the network entity and if a number of retransmission requests does not exceed a maximum number of retransmission requests.

Example 6 may be combined with any of examples 4-5 and further includes receiving, from the network entity, the response to the request to the network entity for the resource for transmitting the TDCP report to the network entity, and includes that the response to the request indicates uplink resources for the UE to transmit the TDCP report to the network entity.

Example 7 may be combined with any of examples 4-6 and includes that transmitting the request to the network entity for the resource for transmitting the TDCP report further includes transmitting the request over at least one of a PUCCH or a PRACH.

Example 8 may be combined with example 7 and includes that resources for the at least one of the PUCCH or the PRACH are configured based on RRC signaling, and includes that different resources of the resources correspond to at least one of different serving cells or different CSI report configurations.

Example 9 may be combined with any of examples 1-8 and includes that the transmitting the TDCP report to the network entity further includes transmitting the TDCP report over a MAC-CE, and includes that an uplink resource request for the MAC-CE is associated with at least one of a SR or a contention-based PRACH.

Example 10 may be combined with example 9 and includes that at least one of the MAC-CE or the PUCCH indicates, for the TDCP report, at least one of a serving cell index, a serving cell group index, a BWP index, a downlink reference signal index, a TDCP for the at least one downlink reference signal, or a CSI report configuration ID.

Example 11 may be combined with any of examples 9-10 and further includes receiving DCI that schedules a PUSCH transmission for the transmitting the TDCP report to the network entity over the MAC-CE.

Example 12 may be combined with any of examples 1-11 and includes that transmitting the TDCP report to the network entity further includes: transmitting the TDCP report over the PUCCH; and receiving ACK/NACK feedback in at least one of a dedicated search space or a CORESET in response to the transmitting the TDCP report to the network entity over the PUCCH.

Example 13 may be combined with any of examples 1-12 and includes that the detection of the triggering condition for the TDCP report is based on a comparison of the measurement value for the at least one of the UE motion or the at least one downlink reference signal to a measurement threshold, and includes that the measurement value is from measuring at least one of a UE speed/velocity, a UE acceleration, a Doppler spread, a Doppler shift, an average delay, a delay spread, or a CSI-RS.

Example 14 may be combined with example 13 and includes that the measurement value of the UE speed/velocity is associated with a slot that includes at least one of a most recent TDCP report or a most recent CSI report, and includes that the measurement value of the TDCP is associated with the most recent TDCP report, and includes that the measurement value of the CSI-RS is associated with the most recent CSI report.

Example 15 is a method of wireless communication at a network entity, including: transmitting, to a UE, control signaling that indicates a triggering condition for a TDCP report; transmitting, to the UE, the at least one downlink reference signal, and includes that a measurement value for at least one of UE motion or the at least one downlink reference signal corresponds to a detection of the triggering condition for the TDCP report; and receiving, from the UE, the TDCP report based on the detection of the triggering condition for the TDCP report.

Example 16 may be combined with example 15 and further includes receiving a UE capability report indicating a capability of the UE for transmitting the TDCP report to the network entity based on the detection of the triggering condition.

Example 17 may be combined with example 16 and includes that the UE capability report indicates at least one of: whether the UE supports the transmission of the TDCP report to the network entity, a property of the at least one downlink reference signal for the detection of the triggering condition for the TDCP report, or a maximum number of serving cells for the receiving of the TDCP report.

Example 18 may be combined with any of examples 15-17 and further includes receiving a request from the UE for a resource, the resource for transmission of the TDCP report to the network entity based on the detection of the triggering condition.

Example 19 may be combined with example 18 and further includes transmitting, to the UE, the response to the request from the UE for the resource for transmission of the TDCP report from the UE, and includes that the response to the request indicates uplink resources for the UE to transmit the TDCP report to the network entity.

Example 20 may be combined with any of examples 18-19 and includes that receiving the request from the UE for the resource for transmission of the TDCP report further includes receiving the request over at least one of a PUCCH or a PRACH.

Example 21 may be combined with example 20 and further includes configuring resources for the at least one of the PUCCH or the PRACH based on RRC signaling, and includes that different resources of the resources correspond to at least one of different serving cells or different CSI report configurations.

Example 22 may be combined with any of examples 15-21 and includes that the receiving the TDCP report from the UE further includes receiving the TDCP report over a MAC-CE, and includes that an uplink resource request for the MAC-CE is associated with at least one of a SR or a contention-based PRACH.

Example 23 may be combined with example 22 and includes that at least one of the MAC-CE or the PUCCH indicates, for the TDCP report, at least one of a serving cell index, a serving cell group index, a BWP index, a downlink reference signal index, a TDCP for the at least one downlink reference signal, or a CSI report configuration ID.

Example 24 may be combined with any of examples 22-23 and further includes transmitting DCI that schedules a PUSCH transmission for the receiving the TDCP report from the UE over the MAC-CE.

Example 25 may be combined with any of examples 15-24 and includes that receiving the TDCP report from the UE further includes: receiving the TDCP report over the PUCCH; and transmitting ACK/NACK feedback in at least one of a dedicated search space or a CORESET in response to the receiving the TDCP report from the UE over the PUCCH.

Example 26 may be combined with any of examples 15-25 and includes that the detection of the triggering condition for the TDCP report is based on a comparison of the measurement value to a measurement threshold, and includes that the measurement value is from measuring at least one of a UE speed/velocity, a UE acceleration, a Doppler spread, a Doppler shift, an average delay, a delay spread, or a CSI-RS.

Example 27 may be combined with example 26 and includes that the measurement value of the UE velocity is associated with a slot that includes at least one of a most recent TDCP report or a most recent CSI report, and includes that the measurement value of the TDCP is associated with the most recent TDCP report, and includes that the measurement value of the CSI-RS is associated with the most recent CSI report.

Example 28 is a method of wireless communication at a UE, including: receiving, from a network entity, control signaling that indicates one or more triggering conditions for a TDCP report, wherein at least one triggering condition of the one or more triggering conditions is based on a measurement value for at least one of a velocity of the UE or an acceleration of the UE; receiving, from the network entity, at least one downlink reference signal for the TDCP report; and transmitting, to the network entity, the TDCP report based on detection of a triggering condition that corresponds to when the measurement value exceeds a threshold value.

Example 29 is an apparatus for wireless communication for implementing a method as in any of examples 1-28.

Example 30 is an apparatus for wireless communication including means for implementing a method as in any of examples 1-28.

Example 31 is a non-transitory computer-readable medium storing computer executable code, the code when executed by at least one processor causes the at least one processor to implement a method as in any of examples 1-28.

1. A method of wireless communication at a user equipment (UE), comprising:
receiving, from a network entity, control signaling that indicates a triggering condition for a time domain channel property (TDCP) report;
receiving, from the network entity, at least one downlink reference signal, wherein a measurement value for at least one of UE motion or the at least one downlink reference signal is used for detection of the triggering condition for the TDCP report; and
transmitting, to the network entity, the TDCP report based on the detection of the triggering condition for the TDCP report.

2. The method of claim 1, further comprising:
transmitting a UE capability report indicating a capability of the UE for transmitting the TDCP report to the network entity.

3. The method of claim 2, wherein the UE capability report indicates at least one of:
a property of the at least one downlink reference signal for the detection of the triggering condition for the TDCP report, or
a maximum number of serving cells for the transmitting of the TDCP report.

4. The method of claim 1, further comprising:
transmitting a request to the network entity for a resource, wherein the resource is for transmitting the TDCP report to the network entity based on the detection of the triggering condition.

5. The method of claim 4, further comprising:
retransmitting the request to the network entity if the UE does not receive a response to the request to the network entity for the resource for transmitting the TDCP report to the network entity and if a number of retransmission requests does not exceed a maximum number of retransmission requests.

6. The method of claim 5, further comprising:
receiving, from the network entity, the response to the request to the network entity for the resource for transmitting the TDCP report to the network entity,
wherein the response to the request indicates uplink resources for the UE to transmit the TDCP report to the network entity.

7. The method of claim 4, wherein the transmitting the request to the network entity for the resource for transmitting the TDCP report comprises:
transmitting the request over at least one of a physical uplink control channel (PUCCH) or a physical random access channel (PRACH).

8. The method of claim 7, wherein resources for the at least one of the PUCCH or the PRACH are configured based on radio resource control (RRC) signaling, and wherein different resources of the resources correspond to at least one of different serving cells or different channel state information (CSI) report configurations.

9. The method of claim 8, wherein the transmitting the TDCP report to the network entity comprises:
transmitting the TDCP report over a medium access control-control element (MAC-CE), and
wherein an uplink resource request for the MAC-CE is associated with at least one of a scheduling request (SR) or a contention-based PRACH.

10. The method of claim 9, wherein at least one of the MAC-CE or the PUCCH indicates, for the TDCP report, at least one of a serving cell index, a serving cell group index, a bandwidth part (BWP) index, a downlink reference signal index, a TDCP for the at least one downlink reference signal, or a CSI report configuration identifier (ID).

11. The method of claim 9, further comprising:
receiving downlink control information (DCI) that schedules a physical uplink shared channel (PUSCH) transmission for the transmitting the TDCP report to the network entity over the MAC-CE.

12. The method of claim 8, wherein the transmitting the TDCP report to the network entity comprises:
transmitting the TDCP report over the PUCCH; and
receiving acknowledgment/negative acknowledgment (ACK/NACK) feedback in at least one of a dedicated search space or a control resource set (CORESET) in response to transmitting the TDCP report to the network entity over the PUCCH.

13. The method of claim 1, wherein the detection of the triggering condition for the TDCP report is based on a comparison of the measurement value for the at least one of the UE motion or the at least one downlink reference signal to a measurement threshold, and wherein the measurement value is from measuring at least one of a UE velocity, a UE acceleration, a Doppler spread, a Doppler shift, an average delay, a delay spread, or a channel state information-reference signal (CSI-RS).

14. The method of claim 13, wherein the measurement value of the UE velocity is associated with a slot that includes at least one of a most recent TDCP report or a most recent channel state information (CSI) report, wherein the measurement value of the TDCP report is associated with the most recent TDCP report, and wherein the measurement value of the CSI-RS is associated with the most recent CSI report.

15. A method of wireless communication at a network entity, comprising:
transmitting, to a user equipment (UE), control signaling that indicates a triggering condition for a time domain channel property (TDCP) report;
transmitting, to the UE, at least one downlink reference signal, wherein a measurement value for at least one of UE motion or the at least one downlink reference signal corresponds to a detection of the triggering condition for the TDCP report; and
receiving, from the UE, the TDCP report based on the detection of the triggering condition for the TDCP report.

16. The method of claim 15, further comprising:
receiving a UE capability report indicating a capability of the UE for transmitting the TDCP report to the network entity.

17. The method of claim 15, further comprising:
receiving a request from the UE for a resource, wherein the resource is for transmitting the TDCP report to the network entity based on the detection of the triggering condition.

18. The method of claim 17, further comprising:
transmitting, to the UE, a response to the request from the UE for the resource for transmitting the TDCP report to the network entity, wherein the response to the request indicates uplink resources for the UE to transmit the TDCP report to the network entity.

19. An apparatus for wireless communication at a user equipment (UE), comprising:
a transceiver;
a memory; and
a processor coupled to the memory and the transceiver, the processor configured to:
receive, from a network entity, control signaling that indicates a triggering condition for a time domain channel property (TDCP) report;
receive, from the network entity, at least one downlink reference signal, wherein a measurement value for at least one of UE motion or the at least one downlink reference signal is used for detection of the triggering condition for the TDCP report; and
transmit, to the network entity, the TDCP report based on the detection of the triggering condition for the TDCP report.

20. The apparatus of claim 19, wherein the processor is further configured to:
transmit a UE capability report indicating a capability of the UE for transmitting the TDCP report to the network entity.
